(19) United States
(12) Patent Application Publication
(10) Pub. No.: US 2004/0138954 A1
(43) Pub. Date: Jul. 15, 2004

(54) System and method for displaying order confirmation information via a browser

(76) Inventors: David G. Norton, Mooresville, NC (US); Christopher Alan Sebes, Charlotte, NC (US)

Correspondence Address: Jeffrey R. McFadden, Womble Carlyle Sandridge & Rice, PLLC, P.O. Box 7037, Atlanta, GA, 30357-0037, US

(21) Appl. No.: 10/695,020

(22) Filed: Oct. 28, 2003

Related U.S. Application Data
(60) Provisional application No. 60/421,646, filed on Oct. 28, 2002.

(51) Int. Cl. G06F 17/60

(52) U.S. Cl. 705/16

(57) ABSTRACT

A software architecture and system, method, and computer readable medium comprising software, for displaying order confirmation information in connection with an audibly placed order. The system includes a point-of-sale information service that generates order information from the audibly placed order. An order confirmation information service transforms the order confirmation information generated by the point-of-sale information service into a browser readable format. The browser readable order confirmation information is comprised of order confirmation information that can be rendered by a browser. A web server (or file server) serves the browser readable order confirmation information to a browser, which displays the browser readable order confirmation information. The system also includes a user interface for displaying information about items logically missing from the ordered items. The logically missing item can be determined and displayed after each item is selected by a user.

### RELATED APPLICATIONS

This application is a non-provisional application claiming the benefit of Provisional Application Serial No. 60/421,646, filed Oct. 28, 2002, the content of which is hereby incorporated in its entirety.

### FIELD OF THE INVENTION

The present invention relates generally to an improved system and method for displaying order confirmation information in connection with a two-way order communication system.

### BACKGROUND OF THE INVENTION

Order confirmation systems (“OCS”), which are well known in the art, were originally conceived as a way to improve the accuracy of orders placed by drive-through customers of fast food restaurants. Typically, the drive-through customer places an order via an order placement device, which consists of a relatively expensive, industrial-grade, weatherproof computer and display. Such devices are located near the drive-through menu board and visually display to the customer a list of the items ordered as the order-taking restaurant employee enters the order information into a point-of-sale information system. Thus, if the order-taking restaurant employee entered an incorrect item, the customer would see the incorrect item displayed and could notify the order-taking employee to make appropriate corrections.

Early display devices used in connection with order confirmation systems included an array or matrix of light emitting diodes (“LED's”) with limited graphical capability. Eventually, display hardware associated with order placement devices became capable of displaying full color images and text.

Software systems associated with order confirmation systems, however, have seen little improvement. Known order confirmation systems have proprietary software interfaces that lack the capability of displaying multimedia order confirmation information. Conventional software systems associated with order confirmation systems also do not allow for easy and efficient customization of the order confirmation information displayed to the customer.

In addition, vendors of order confirmation systems typically require the use of proprietary order placement devices, which include displays that are relatively expensive. Typically, such order placement devices are serially connected to other components of the order confirmation system, such as an order receiving device operated by the restaurant employee and/or a central server for providing point-of-sale information services and/or order confirmation information services. In addition, it is difficult, and sometimes impossible, to integrate such proprietary order placement devices into software and hardware used in connection with pre-existing order confirmation systems.

Thus, what is needed is a software architecture and a system and method for displaying order confirmation information that is open and flexible and can be used with non-proprietary software and hardware.

An evolving feature of order confirmation systems is the suggestive selling via the graphical display of related, but unordered items upon “placement” of an order. (An order may be considered “placed” when the customer completes the order and the order confirmation system totals the order and displays the total to the customer.) One known order confirmation system available as OrderSsmart™ from Techknow Incorporated of Duncan, S.C. suggestively sells products at the order total screen. As an example, if a customer orders, a cheeseburger, french fries and a drink, upon totaling the order, the Technknow system detects the absence of a dessert item, the system would then cause a desert item to be displayed to the customer, suggestively selling the dessert item.

A disadvantage of the Techknow system, however, is that the suggestive selling is performed at order placement level, rather than suggestively selling at the item selection level. A disadvantage of suggestively selling at the order placement level is that there is only one opportunity per transaction to suggestively sell a product or service. Thus, what is needed is an order confirmation system and method for suggestively selling products that overcomes the disadvantages associated with known suggestive selling systems and methods.

### SUMMARY OF THE INVENTION

The present invention is a software architecture and system and method for displaying order confirmation information in connection with an audibly placed order. The system includes a point-of-sale information service that generates order information from the audibly placed order. An order confirmation information service transforms the order confirmation information generated by the point-of-sale information service into a browser readable format. The browser readable order confirmation information is comprised of order confirmation information that can be rendered by a browser. A web server, or other file server, serves the browser readable order confirmation information to a browser, which displays the browser readable order confirmation information.

The present invention also includes an order confirmation information service that displays to the browser suggestive selling information at the item placement level by refreshing the order entry page after each item selection.

These and other aspects of the present invention as disclosed herein will become apparent to those skilled in the art after a reading of the following description of the preferred embodiments and drawings. The description and drawings are for the purpose of describing a preferred embodiment of the invention and are not intended to limit the present invention.

### BRIEF DESCRIPTION OF THE DRAWINGS

FIG. 1 is a diagram of an exemplary business in connection with which an embodiment of the present invention is used.

FIG. 2A is a diagram of the logical components of a first embodiment the present invention in a single processor configuration.

FIG. 2B is a diagram of the logical components of a first embodiment of the present invention in a multiple processor configuration.

FIG. 3A is a diagram of the physical components of the present invention in a single processor configuration.

FIG. 3B is a diagram of the physical components of the present invention in a multiple processor configuration.

FIG. 4A is a diagram of the logical components of a second embodiment of the present invention in a single processor configuration.

FIG. 4B is a diagram of the logical components of a second embodiment of the present invention in a multiple processor configuration.

FIG. 5 is a diagram of the logical components of a second embodiment of the present invention in a multiple processor configuration, which shows the data flow and processing logic in more detail.

FIG. 6 is a screenshot of an exemplary display of the present invention.

Repeat use of reference characters in the present specification and drawings is intended to represent same or analogous features or elements of the invention.

### DETAILED DESCRIPTION OF THE PREFERRED EMBODIMENT

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

Generally, the invention is directed to a system and method of transmitting and displaying order confirmation information in connection with a two-way order communication system that is used, for example, in connection with a fast food restaurant. Such order communication systems, which typically include an order placement device and an order receiving device, are well known in the art. An example of such an order communication system is disclosed in U.S. Pat. No. 5,907,275 to Battistini, et al., the contents of which are hereby incorporated by reference.

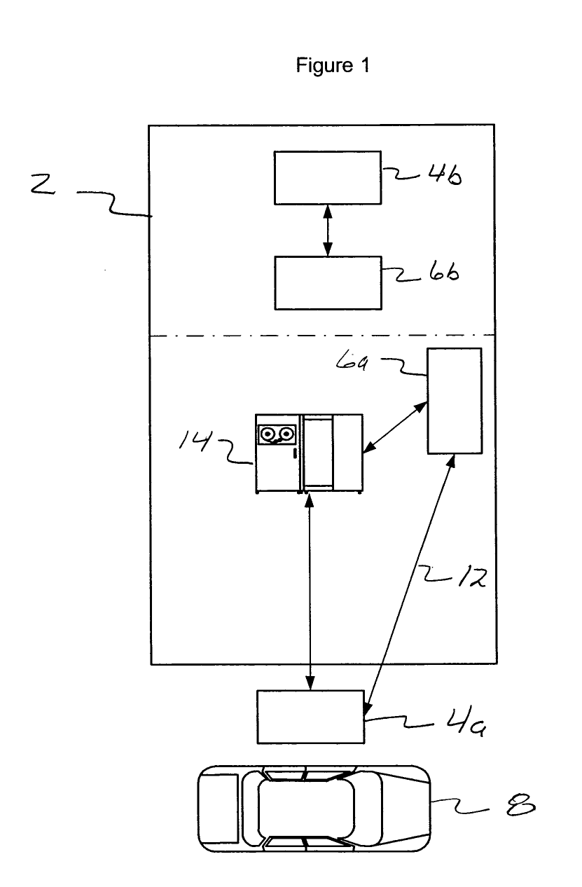

FIG. 1 is a diagram of an exemplary business, a fast food restaurant 2, in connection with which an embodiment of the present invention is used. The order communication system 10 includes one or more order placement devices 4a, 4b. An order placement device may be remote from the restaurant 2, such as in the case of an order placement device 4a used in connection with a drive-through customer. Alternatively, the order placement device 4b may be essentially co-located with one or more order receiving devices 6b, such as in the case of an order placement device 4b used in connection with a walk-up customer. Each order placement device 4a, 4b is paired with at least one order receiving device 6a, 6b, each of which is typically located within the restaurant 2.

The order communication system 10 includes a communication link 12, which allows an order-taking employee of the restaurant 2 at the order receiving device 6a to communicate with a customer, typically in a car 8, via the order placement device 4a. As can be appreciated by those skilled in the art, the communication link can be wired or wireless, both of which are within the scope of the present invention. The communication between the order placement device 4a and the order receiving device 6a may be audio only or audiovisual. As is appreciated by those skilled in the art, if the communication between the order receiving device 6a and the order placement device 4a is audiovisual both the order receiving device 6a and the order placement device 4a must be configured with a camera for acquiring video images, a monitor for displaying video images, a microphone for acquiring audio signals and a speaker for outputting the audio signals. The customer can observe a menu board, which includes various menu items and their prices, as well as promotional information. The customer uses the order placement device 4a to communicate an order via the communications link 12 to the restaurant employee, who enters the order information into the order receiving device 6a.

Generally, order information received at the order receiving device 6a via the order placement device 4a is entered into the point-of-sale information system 14 by the restaurant employee. Order confirmation information is generated from the point-of-sale information system and the order confirmation information is then displayed, usually simultaneously, on both the order placement device 4a and order receiving device 6b. After the drive-through customer completes the process of placing an order, the customer will proceed to a window 16 to pay for and receive the ordered products.

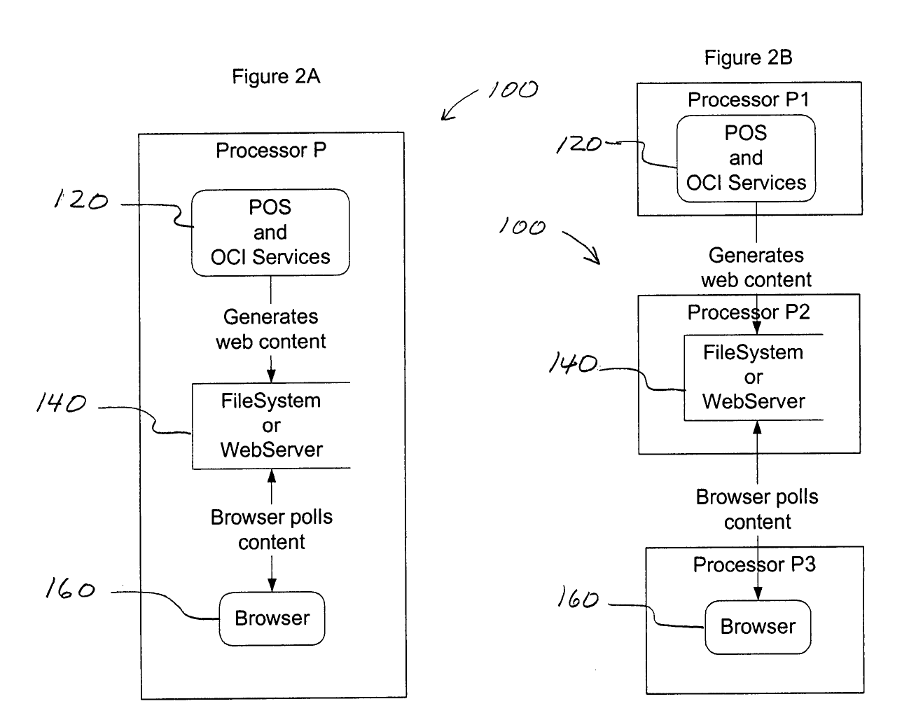

FIG. 2A is a diagram of the logical components of a first embodiment of the present invention in a single processor configuration. As is appreciated by those skilled in the programming art, the logical functions of the system 100 can be included in a single software module or distributed across more than one software module, both of which are included within the scope of the invention. As shown in FIG. 2A, the order confirmation system 100 includes a register with processor P. The software module 120 provides a point-of-sale (“POS”) information service. Point-of-sale information systems are well known in the art and are available from, for example, Progressive Software, Inc. of Charlotte, N.C. Point-of-sale information systems provide one or more of the following functions: providing a graphical user interface, sales tax calculation, menu configuration editor, foreign currency conversion, unattended end-of-day processing, speed-of-service reporting, cash management, in-store messaging and a “visual dashboard,” which is a control panel for displaying in-store operational information.

The software module 120 also provides an order confirmation information service. The order confirmation information service of the system 100 generates order confirmation information based on the point-of-sale information acquired by the point-of-sale information system. In one preferred embodiment, the order confirmation information is converted by the order confirmation information service from a native, proprietary format, which is generated and understood by the point-of-sale information system, into a format such as, Hypertext Markup Language (“HTML”), that can be viewed by a browser 160. In the embodiment illustrated in FIG. 2A, the point-of-sale information service, which generates the point of sale information, is logically coupled with the order confirmation information service, which converts the order confirmation information generated by the point-of-sale information service into a browser readable format. By “browser,” we mean any software program running on any computing device, wherein the software can render or display tagged data on the computing device. For example, the computing device can be a personal computer, a personal digital assistance, a web-enabled cellphone, a display for a pre-existing order confirmation system, etc.

The converted order confirmation information is transmitted to a conventional web server (or a file server) 140, which in turn transmits the information to the browser 160. The browser 160 displays the order confirmation information to the customer via a display (not shown). The display may be any display device, such as a liquid crystal display (“LCD”) or a light emitting diode (“LED”) display, both of which are well known devices for displaying order confirmation information.

As is appreciated by those skilled in the programming art, the logical functions of the system 100 can be provided by a single processor or they can be distributed across more than one processors, both of which are included within the scope of the invention. FIG. 2A illustrates a first embodiment of the invention in which the functions of the system 100 are provided by a single processor P; FIG. 2B illustrates the first embodiment of the invention in which the functions of the system 100 are distributed across multiple processors, P1, P2 and P3. Preferably, processor P1 is associated with an order receiving device, such as a register operated by a restaurant employee, processor P2 is associated with a back office server and processor P3 is associated with an order placement device.

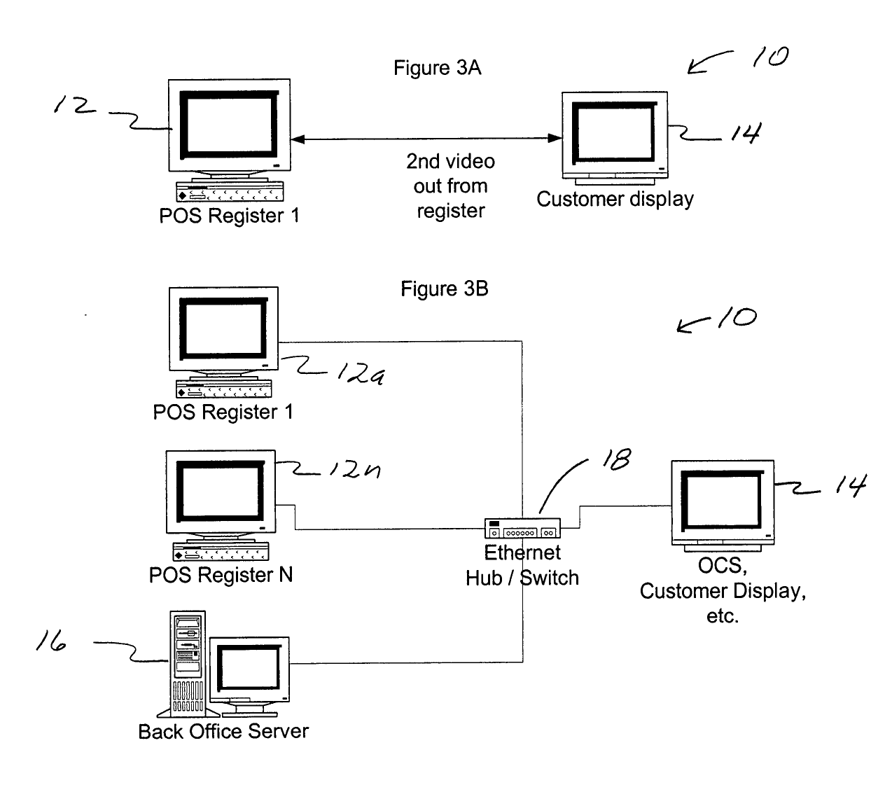

FIG. 3A is a diagram of the physical components of the present invention in a single processor configuration in which an order is received from a walk-up customer. The system 10 includes a register 12, which functions as an order receiving device. The register 12 includes a processor for providing the point-of-sale information service and the order confirmation information service. The register 12 also includes a display for displaying point-of-sale and/or order confirmation information to the order-taking restaurant employee. The system 10 also includes a display 14 for displaying order confirmation information to a customer. As can be appreciated by those skilled in the art, in the embodiment illustrated in FIG. 3A, the communication between the restaurant employee and the walk-up customer is direct audio communication.

FIG. 3B is a diagram of the physical components of the present invention in a multiple processor configuration in which order information is received from a drive-through customer. The system 10 includes one or more registers 12a-12n, each of which functions as an order receiving device. Each register 12a-12n includes a processor that may provide the point-of-sale information service and the order confirmation information service. Each register 12a-12n also includes a display for displaying point-of-sale and/or order confirmation information to the order-taking restaurant employee. The system 10 also includes a display 14 for displaying order confirmation information to a customer. As can be appreciated by those skilled in the art, in the embodiment illustrated in FIG. 3B, the communication between the restaurant employee and the walk-up customer is either electronic audio communication or electronic audiovisual communication.

As further shown in FIG. 3B, the system 10 also includes a back office server 16. The back office server 16 may provide the point-of-sale information service and/or the order confirmation information service. In addition, the back office server 16 also may provide web service to the display 14. Preferably, the components of system 10 communicate with each other via a packet-based communications network, such as an Internet Protocol (“IP”) network. In such a case, an Ethernet switch/hub 18 facilitates such communication.

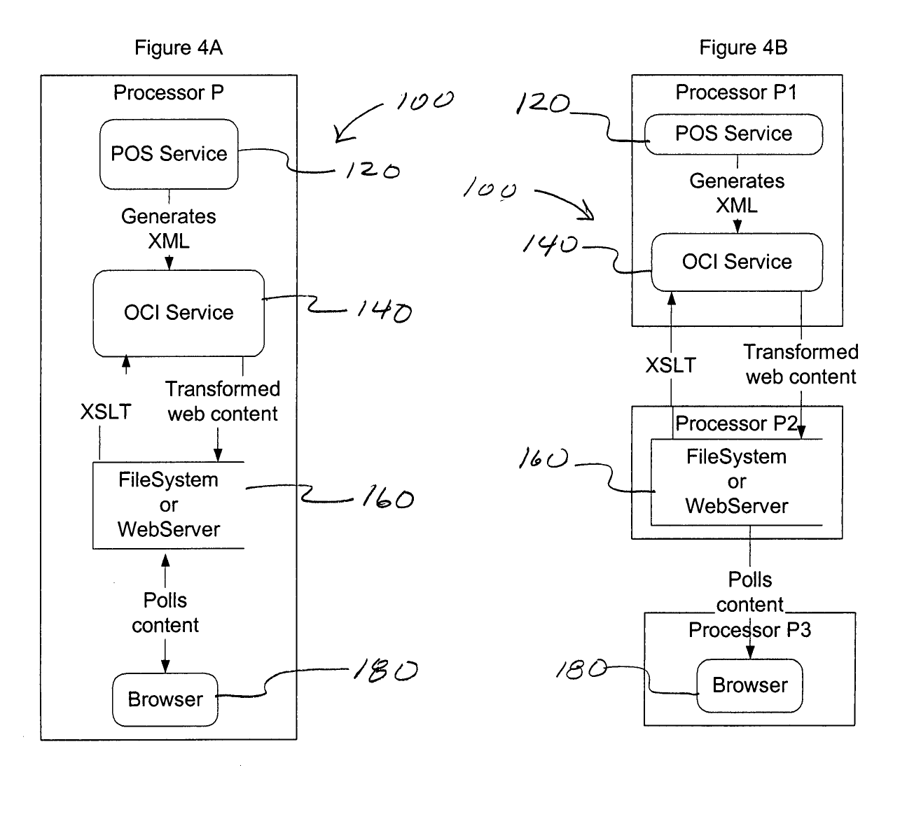

FIG. 4A is a diagram of the logical components of a second embodiment of the present invention in a single processor configuration. As illustrated in FIG. 4A, the system 100 includes a register with processor P for providing a point-of-sale information service 120 that is logically decoupled from the order confirmation information service 140. The functions of the point-of-sale information service 120 and the order confirmation information service 140 are described in detail above. As discussed above, the point-of-sale information service 120 generates order confirmation information that is transmitted from the point-of-sale information service 120 to the order confirmation information service 140. Preferably, the order confirmation information is converted from a format native to the point-of-sale system to a format that is commonly understood by a wide variety of computer programs, such as extensible markup language (“XML”). While XML-tagged data is the preferred format for the order confirmation information, the invention is not limited to the use of XML-tagged data. Any browser readable data format or language that describes a document or data file in terms of its organization structure and content parts and their relationship, including any language using markups or tags to describe the document or data file, is within the scope of the invention.

As is known to those skilled in the art, XML is a flexible way to create common or standard information formats and share both the format and the data on the Web, intranets, and elsewhere. XML is similar to HTML insofar as both XML and HTML contain markup symbols to describe the contents of a page or file. HTML, however, describes the content of a Web page (mainly text and graphic images) only in terms of how it is to be displayed and interacted with. XML, however, describes the content in terms of what data is being described. This means that an XML file can be processed purely as data by a program or it can be stored with similar data on another computer or, like an HTML file, that it can be displayed.

XML is “extensible” because, unlike HTML, the markup symbols are unlimited and self-defining. XML is actually a simpler and easier-to-use subset of the Standard Generalized Markup Language (SGML), the standard for how to create a document structure.

The order confirmation service 140 uses the Extensible Stylesheet Language (“XSL”) to transform the XML-tagged order confirmation information received from the point-of-sale information service 120. The XSL Transformation (“XSLT”) is a standard way to describe how to transform or change the structure of an XML document into an XML document with a different structure. XSLT can be thought of as an extension of the Extensible Stylesheet Language (XSL), which is a language for formatting an XML document. For example, XSL can dictate how data described in the XML document should be presented in a Web page. XSLT shows how the XML document should be reorganized into another data structure (which could then be presented by following an XSL style sheet). The coding for the XSLT is also referred to as a “stylesheet” and can be combined with an XSL stylesheet or be used independently.

The transformed XML-tagged data is transmitted from the order confirmation information service 140 to a web server (or file server) 160. The web server 160 then transmits the order confirmation information to the browser 180, which displays the order confirmation information to a customer and/or the order-taking restaurant employee.

The system of the present invention can display suggestive selling information (images, video, text, etc.), which can be updated in “real-time” during the order entry process based on events that occur during the order entry process. By “real-time” we mean, that the displayed suggestive selling information is updated after each item is selected during the order entry process. Examples of events that can occur during order entry that may cause the displayed suggestive selling information to be updated may include adding or removing an item to or from an order, ordering a certain combination of items, determining that one or more items are missing from an order, determining that a predetermined amount of time has passed since a particular suggested item was displayed or first shown, or determining that a predetermined number of orders have been placed.

In an embodiment, the system would be rules based so that a user, such as a fast food restaurant operator, could customize the rules and display suggestive selling information specified by the user based on events specified by the user. The rules base also could specify suggestive selling information to be displayed by default, i.e., no specified event has occurred or after certain specified events have occurred in a specified order. The rules base also could specify suggestive selling information to be displayed when no order is being taken.

The suggestive selling information could be displayed on one or more displays simultaneously. For example, suggestive selling information could be displayed on a customer-facing video display associated with an in-store register and on a display embedded an overhead menu board. In addition, the suggestive selling information displayed on the two displays could be different. The overhead menu board display could display suggestive selling information based on events that occur while a plurality of orders are being entered. For example, if french fries are missing from 2 of 3 orders being entered, an image of an order of french fries could be displayed on the overhead menu board. At the same time, however, if a drink is missing from only 1 of 3 orders being entered, an image of a drink could be displayed on an individual customer-facing display, while the french fries are displayed on the overhead menu board.

FIG. 4B is a diagram of the logical components of a second embodiment of the present invention in a multiple processor configuration. As illustrated in FIG. 4B, the functions of the system 100 are distributed across multiple processors, P1, P2 and P3. Preferably, processor P1 is associated with an order receiving device, such as a register operated by a restaurant employee, processor P2 is associated with a back office server and processor P3 is associated with an order placement device. The point-sale-information service 120 and the order confirmation information service 140 may run on processor P1. The web server (or file server) 160 may run on processor P2. The browser 180 may run on processor P3.

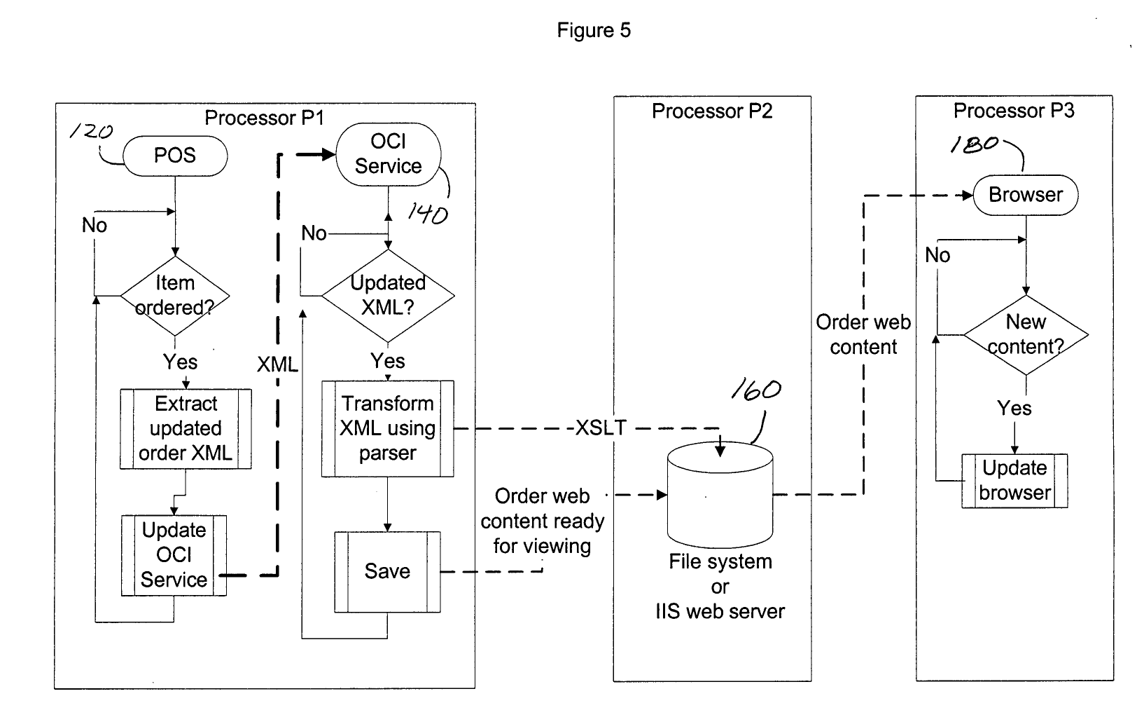

FIG. 5 shows the data flow and processing logic of the logical components of the system 100 in more detail. The point-of-sale information service 120, which is an executable program in a preferred embodiment, waits for an item to be ordered. If an item is ordered, the order confirmation information is extracted and converted into a browser readable format, such as XML-tagged data. The XML-tagged order confirmation information is transmitted by the point-of-sale information service 120 to the order confirmation information service 140.

The order confirmation information service 140, which is an executable program in a preferred embodiment, transforms the order confirmation information. The order confirmation information, which is XML-tagged data, can be transformed using, for example, an XML parser, such as the Microsoft XML parser available from Microsoft Corporation of Redmond, Wash. An XML parser is software that reads a file or document containing XML-tagged data and makes the data in it available to an XSL style sheet, such as an XSLT file. The XSLT file, which may be supplied by the restaurant operator, transforms the XML-tagged data into a format readable by a browser 180, preferably, HTML.

After the XML-tagged order confirmation information is transformed it is transmitted to a web server 160, such as the Internet Information Server available from Microsoft Corporation or some other file system. In a preferred embodiment, the XSLT files that are provided by the restaurant operator are also stored on a web and/or file server 160. The browser readable order information is then sent to a browser 180. The browser can be, for example, Internet Explorer, which is available from Microsoft Corporation, or any other client program capable or rendering HTML or XML documents.

As appreciated by those skilled in the art, in equally preferred embodiments, the transformation of the XML-taggged order confirmation information can be performed by the processor upon which either the web server (or file server) 160 or the browser 180 is running in order to maximize system performance.

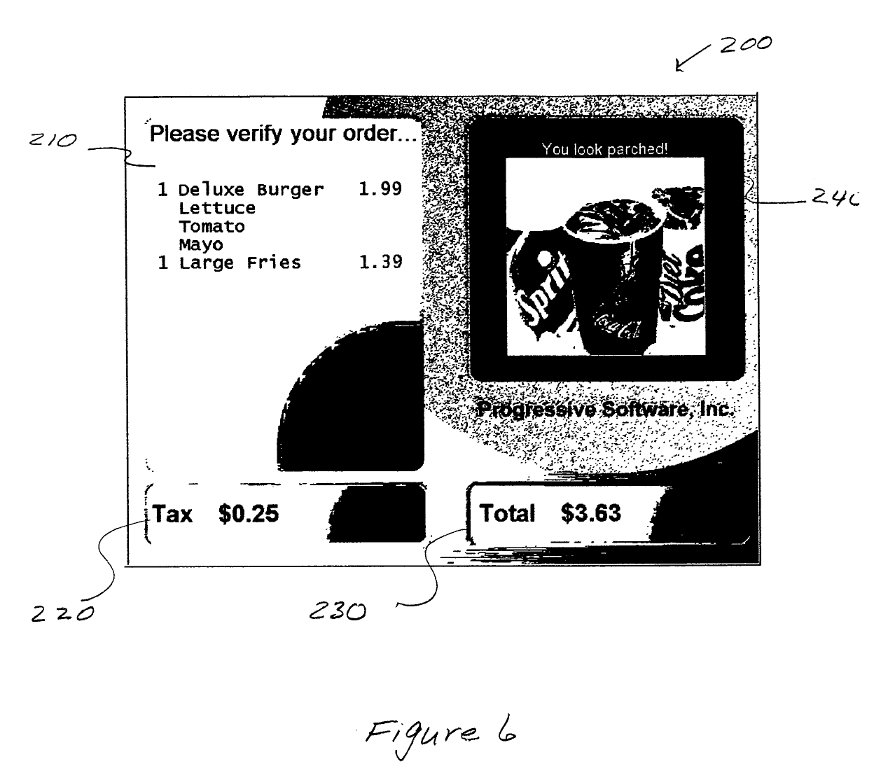

FIG. 6 is a screen shot of an exemplary display 200 of order confirmation information generated, transformed and/or transmitted by the system 100. As illustrated in FIG. 6, the display 200 can have one or more display areas, which can display any type of information that can be rendered by a browser. In a preferred embodiment, the display 200 includes a first area 210 for displaying the quantity of each item ordered, a description of the item and the price of the item. The display 200 has a second area 220 for displaying the amount of sales tax due for the items ordered and displayed in the first area 210. The display 200 has a third area 230 for displaying the total amount due for the items displayed in the first area 210, including sale tax, which is displayed in the second area 220. The display 200 has a fourth area 240, which can be programmed to display any type of information desired by the restaurant operator.

In a preferred embodiment, advertising information can be displayed in the fourth area 240. In another equally preferred embodiment, processing logic can be used to determine if any products are logically missing from the order. For example, if a customer orders a burger and french fries, but no beverage has been ordered, the system can be programmed to display in the fourth area 240 a message such as, “Would you like an ice cold Coke with your burger and fries?” In another equally preferred embodiment, the system can be configured to display in the fourth display area 240 a graphic representation of the logically missing menu item, such as, a serving of Coke.

As can be appreciated by those skilled in the art, any number of additional display areas can be included in the display 200. In another equally preferred embodiment, advertising information for goods or services of third parties, such as, a nearby business could be displayed in one of the display areas of the display 200.

While preferred embodiments of the present invention have been described above, it is to be understood that any and all equivalent realizations of the present invention are included within the scope and spirit thereof. Thus, the embodiments depicted are presented by way of example only and are not intended as limitations upon the present invention. While particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

What is claimed is:

1. A system for displaying order confirmation information in connection with an audibly placed order, the system comprising:
a. a point-of-sale information service for generating order information received via the audibly placed order;
b. an order confirmation information service for transforming order confirmation information generated by the point-of-sale information service into a browser readable format, wherein the browser readable order confirmation information is comprised of order confirmation information that can be rendered by a browser;
c. a file server for serving the browser readable order confirmation information; and
d. a browser for requesting the order confirmation information from the file server and displaying the browser readable order confirmation information.

2. The system of claim 1, wherein point-of-sale information service converts the order confirmation information from a format native to the point-of-sale information service to a tagged data format.

3. The system of claim 1, wherein the tagged data format is XML-tagged data.

4. The system of claim 2, wherein the point-of-sale order information service transmits the tagged order confirmation information to the order confirmation information service.

5. The system of claim 4, wherein the point-of-sale information service transmits the tagged order confirmation information to the order confirmation information service at a predetermined time.

6. The system of claim 5, wherein the predetermined time is after a new item ordered.

7. The system of claim 4, wherein the order confirmation information service further comprises a parser, wherein the parser transforms the tagged order confirmation information into a browser readable format.

8. The system of claim 7, wherein the browser readable format is HTML.

9. The system of claim 7, wherein the browser readable order confirmation information is transmitted to the file server.

10. The system of claim 9, wherein the browser readable order confirmation information is transmitted by the file server to the browser in response to a request from the browser.

11. The system of claim 1, wherein the file server is a web server.

12. The system of claim 1, wherein the order confirmation information service is configured to select suggestive selling information.

13. The system of claim 12, wherein the suggestive selling information selected by the order confirmation information service is transmitted by the order confirmation information service to the file server.

14. The system of claim 13, wherein the suggestive selling information is transmitted by the file server to the browser.

15. The system of claim 14, wherein the selected suggestive selling information is displayed by the browser.

16. The system of claim 12 wherein the suggestive selling information selected by the order confirmation information service is based on a rules base and responsive to an item selected by the browser.

17. A method for displaying order confirmation information in connection with an audibly placed order, the method comprising:
a. generating order information via a point-of-sale information service, wherein the order information is based on the audibly placed order;
b. transforming order confirmation information generated by the point-of-sale information service into a browser readable format via a order confirmation information service, wherein the browser readable order confirmation information is comprised of order confirmation information that can be rendered by a browser;
c. serving the browser readable order confirmation information via a file server; and
d. requesting the order confirmation information from the file server via a browser and displaying the browser readable order confirmation information via the browser.

18. A computer readable medium containing a computer software for displaying order confirmation information in connection with an audibly placed order, the computer software comprising program instructions that:
a. generates order information via a point-of-sale information service, wherein the order information is based on the audibly placed order;
b. transforms order confirmation information generated by the point-of-sale information service into a browser readable format via a order confirmation information service, wherein the browser readable order confirmation information is comprised of order confirmation information that can be rendered by a browser;
c. serves the browser readable order confirmation information via a file server; and
d. requests the order confirmation information from the file server via a browser and displaying the browser readable order confirmation information via the browser.

19. A computer readable medium containing a computer software for displaying a user interface to an order confirmation information system for use in connection with an audibly placed order, the computer software comprising program instructions that:
a. displays in a first area one or more items ordered by a customer;
b. displays in a second area sales tax information for each of the items displayed in the first area;
c. displays in a third area the total amount due, including sales tax, for the items displayed in the first area; and
d. displays in a fourth area suggestive selling information based on one or more events that occur during an order entry process.

20. The computer readable medium of claim 19, wherein the suggestive selling information is displayed in the fourth area, wherein the suggestive selling information displayed in the fourth area is updated after each item that is displayed in the first area is entered into the order confirmation system.
